(19) United States
(12) Patent Application Publication
(10) Pub. No.: US 2001/0032111 A1
(43) Pub. Date: Oct. 18, 2001

(54) System for ordering and manufacturing a tangible device

(76) Inventors: Elmer W. Jensen JR., Chadds Ford, PA (US); Lee Melbourne Cook, Steelville, PA (US); William D. Budinger, Key West, FL (US)

Correspondence Address: Gerald K. Kita, Rodel Holdings, Inc., Suite 1300, 1105 North Market Street, Wilmington, DE, 19899, US

(21) Appl. No.: 09/749,082

(22) Filed: Dec. 27, 2000

Related U.S. Application Data
(60) Provisional application No. 60/173,934, filed on Dec. 30, 1999.

(51) Int. Cl. G06F 17/60

(52) U.S. Cl. 705/8

(57) ABSTRACT

A system, method and apparatus by which a customer determines ordering, manufacturing at a selected site and delivery without shipping of a tangible device sold by using a seller's computer (3) receiving an order for a tangible device from a customer, selecting manufacturing process commands to manufacture the device as ordered, verifying that the site has the capability and an open schedule to manufacture the device, scheduling the manufacturing during the open schedule, and providing an order fulfillment schedule and status tracking of the order, a manufacturing control computer (4) providing manufacturing process commands to a production unit (5) at the site, and providing a record of maintenance fulfillment indicating capability and readiness of the production unit to manufacture the tangible device.

### CROSS REFERENCE TO RELATED APPLICATION

This application claims the benefit of Provisional Application No. 60/173,934, filed Dec. 30, 1999.

### FIELD OF THE INVENTION

The invention includes a system and method by which an order that is placed by a customer is used to manufacture a tangible device at a site that is selected by the customer, instead of a site selected by either the seller or the manufacturer.

### BACKGROUND OF THE INVENTION

A communications network, such as, the Internet, is connected to a public communications exchange, such as a telephone exchange or community cable network or a wireless communications network. A computer, such as, a network appliance, a personal computer or other digital signal communications apparatus, connects to the public exchange, and communicates over the network to operate a computer controlled machine that itself is connected by a public exchange to the network at a remote site.

According to a known system for performing commercial transactions over a communications network, an article of manufacture is made to order, by beginning with a customer communicating the order by computer over a communications network, such as, the Internet, to a seller's computer that uses the order to communicate manufacturing instructions over the network to various sites where supply, manufacturing and assembly of the article is performed in synchronization instead of serially in time, which sites are under the control of the seller or under the control of the manufacturer. This, made to order, system speeds manufacture, reduces manufacturing inventory, and provides a fully manufactured article ready for shipment to the customer. This system uses the communications network to manufacture tangible devices and assemble them into a fully manufactured article, but requires multiple transactions to arrange for shipment of the tangible devices and payment of shipment charges.

According to another known system for performing commercial transactions over a communications network, a manufacturing apparatus of information presentation media, such as, a poster printer, a musical score printer, an optical disk recorder or a digital file maker, is located at a seller's store, and is commanded by a customer, who visits the store, to manufacture a printed poster or printed musical score, or to manufacture an optical disk recording or a digital file of music or other digitally reproduced and stored information, according to the order placed by the customer. The order is communicated over a communications network, such as, the Internet, to a seller's computer that uses the customer's order to access information recorded on a digital master file, and to communicate manufacturing instructions over the network to the manufacturing apparatus at the store, which manufactures a digitally created reproduction of the digital master file in a form of information presentation media that is specified by the order placed by the customer. This known system manufactures and delivers intangibles in the form of digital data for machine recognition, as well as, further digital data that is machine converted into information presentation media for human recognition. The store is a site selected by the seller of goods, which is inconvenient for the customer.

### SUMMARY OF THE INVENTION

A system for performing commercial transactions over a network includes, a system by which a customer determines: ordering, manufacturing and delivery at a single site without shipment, of a tangible device supplied by a seller or vendor. The system further includes a process of, manufacturing a tangible device to an order at a single site selected by the customer, instead of at a site, or multiple sites, as selected either by the seller or by vendors supplying goods and services to the seller. The system provides for delivery of the tangible device at the site without shipping, which efficiently completes fulfillment of the customer's order without the need for further transactions to arrange for shipping and for the payment of shipping charges. Further, the customer has a property interest in the production unit that performs manufacturing of the tangible device. The seller provides instructions to supply chain managers to perform on-site maintenance of the production unit, and materials replenishment for materials consumed by manufacturing operations.

An embodiment of the invention will now be described by way of example, with reference to the accompanying drawings, according to which:

### DESCRIPTION OF THE DRAWINGS

FIG. 1 is a schematic diagram of a system by which ordering and manufacturing is performed;

FIG. 1A is a schematic diagram of a system including process steps for the performance of ordering and manufacturing;

FIG. 2 is a side view of a tangible device in the form of a polishing pad.

FIG. 3 is a top view of the pad disclosed by FIG. 2;

FIG. 4 is a magnified view of a cross-section of a groove

FIG. 5 is a cross section of a polishing carrier;

FIG. 6 is a top view of a tangible device in the form of a wafer carrier;

FIG. 7 is a diagram of a system for handling an order, scheduling manufacturing and controlling manufacturing process commands; and

FIG. 8 is a diagram of a system for computer control of a device production unit.

### DETAILED DESCRIPTION

The invention is directed toward a system for a customer to purchase and to obtain manufacture and delivery of a tangible device being sold by a seller. The term “tangible device” is meant to include a palpable object having definite physical structure. The term “tangible device” excludes intangibles, such as data for machine recognition or information in any form of communications media for human recognition. Thus, the term tangible device is meant to exclude machine readable data, and information in digital form or in any form of audio, video and printed communications media. That is, machine recognized data in the form of magnetic media or optical media or digital media, or human recognized information that is in the form of video media, audio media or printed media, is excluded from being tangible devices. Tangible devices on which data is encoded or tangible devices on which information for human recognition is carried, such as, video display panels, tapes, disks, paper, are intended to be included within the meaning of the term “tangible device”. A tangible device includes any class of object, such as an article of manufacture, device and apparatus, capable of manufacture by computer controlled manufacturing operations performed independently of human intervention, except for maintenance of machinery and replenishment of consumables.

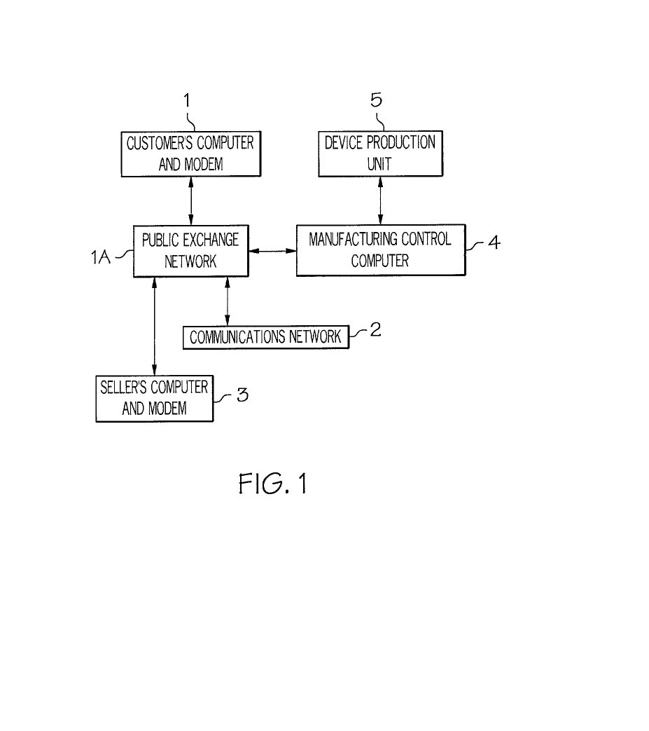

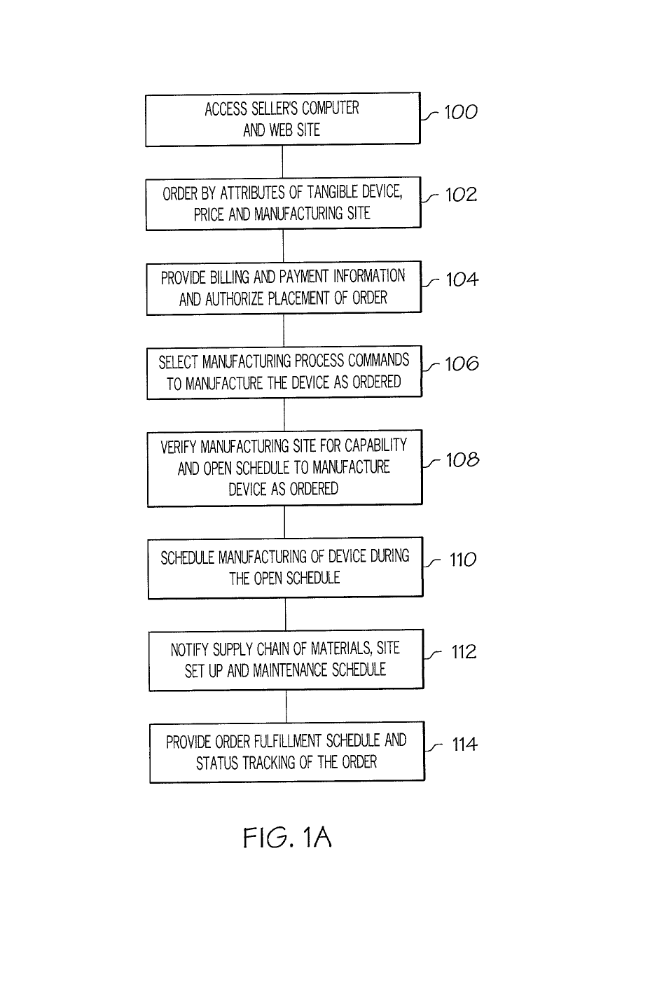

FIG. 1 discloses a system for ordering and manufacturing a tangible device. A customer uses a customer's computer and modem (1) connected to a public communications exchange network (1A), that in turn, connects with a communications network (2), such as, the Internet, to contact a seller, by way of the seller's computer (3). The seller's computer (3) includes a central processor unit that uses a number of different processors that send or route digitally encoded information to, and retrieve digitally encoded information from, corresponding data bases. Following placement of the order, the seller's computer selects the manufacturing process and the manufacturing process commands necessary to be supplied to a manufacturing system control computer (4) controlling a controlled device production unit (5) or manufacturing apparatus that will manufacture the tangible device ordered by the customer. The manufacturing control computer (4) includes a central processor unit that uses a number of different processors that send or route digitally encoded information to, and retrieve digitally encoded information from, corresponding data bases.

FIG. 1A further discloses a process, wherein, at step (100), using a web browser on the customer's computer (1), the customer accesses a website of the seller on the seller's computer (3). The website is interactive with the customer's web browser, enabling the customer to use the customer's computer (1) and web browser to perform a series of commercial transactions: the customer completes a customer order by which the customer orders a tangible device, at step (102), by selecting the tangible device and the attributes of the tangible device, as identified by the seller's website. Further, the customer order specifies a manufacturing site and a requested delivery date.

At step (104), the seller's computer (3) and website obtains billing and payment information from the customer's order, which authorizes the customer to place the order.

Following placement of the order, at step (106), the seller's computer (3) selects the manufacturing process and the manufacturing process commands necessary to be supplied to a manufacturing system control computer (4) controlling a controlled device production unit (5) that will manufacture the tangible device ordered by the customer.

At step (108), the seller's computer (3) matches the manufacturing process and process commands with the capabilities and the readiness status of the production unit at the site selected by the customer. The seller's computer (3) examines the schedule of the production unit for an opening in the schedule that is sufficient to perform the manufacturing process from beginning to end, and within the delivery date requested by the customer's order. At step (110), the seller's computer schedules the manufacturing site to manufacture the tangible device during the open schedule.

At step (112), the seller's computer (3) notifies the supply chain managers who are employees of the seller or of the customer, or who are vendors of goods and services to the seller or to the customer, with information about the materials needed to manufacture the tangible device ordered by the customer. Further, the seller's computer notifies the supply chain managers of the need for site set-up and maintenance of the production unit to operate during the manufacturing schedule allotted for manufacture of the tangible device, as ordered by the customer. This information and notification enables readiness in advance of the manufacturing schedule, and anticipates the amount to which materials need replenishment when manufacturing occurs according to the schedule.

At step (114) the seller's computer (3) creates an order fulfillment schedule and an order status tracking report for verifying the status of the order. The order is confirmed to the customer, along with confirmation of the production unit and the manufacturing schedule within the delivery date as ordered by the customer. The customer uses the order status tracking report to provide inquiries of the seller's computer (3) about the status and whereabouts of the order and device that was ordered.

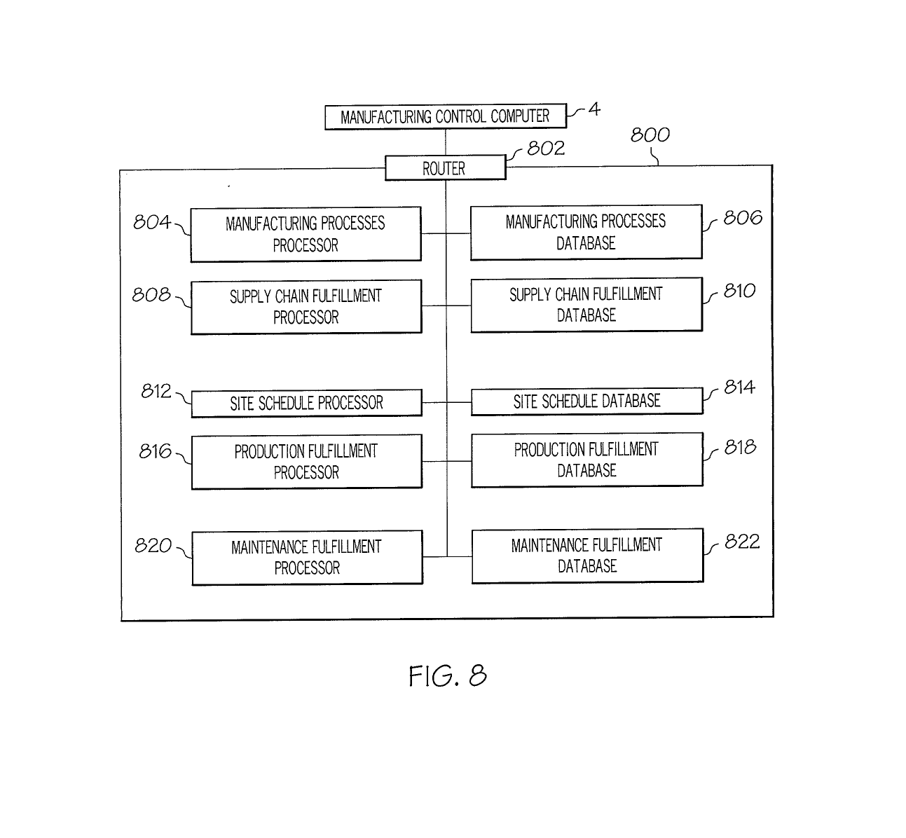

FIG. 7 discloses a computer operated system including an apparatus (700) for ordering and manufacturing a tangible device, connected to the seller's computer (3). The apparatus (700) includes a central processor unit, and is disclosed with a distributed architecture that includes a router (702) for routing digital communications among distributed sections or parts of the apparatus (700). An integrated architecture eliminates the need for the router (702). An attributes processor (704) stores and retrieves information stored in an attributes data base (706), to identify and display various devices by their attributes on the seller's website. A billing and payment processor (708) stores and retrieves information stored in a billing and payment database (710), and is used by the seller's computer (3) to verify billing and payment for a device ordered by the customer from the website. Further, the ownership interest of the customer in the production unit (5) that is specified by the customer is verified, and is used to apportion, by and according to the ownership interest, the financial recording and reporting of; income, interest, depreciation, insurance, taxes and accounting adjustments. A manufacturing process commands processor (712) stores and retrieves information from a manufacturing process commands data base (714), which the seller's computer (3) matches the manufacturing processes and the manufacturing process commands to those being required to manufacture the device that is displayed on the website and ordered by the customer. A manufacturing site processor (716) stores and retrieves information from a manufacturing site data base (718), and is used by the seller's computer (3) to verify that the production unit (5) or manufacturing apparatus, at the site selected by the customer, has the capability to perform the manufacturing commands necessary to manufacture the device ordered by the customer. The capability includes, the types of processes and machines available at the site, the state of readiness and the state of repair or disrepair. A manufacturing schedule processor (720) stores and retrieves information from a manufacturing schedule database (722), and is used by the seller's computer (3) to determine whether the manufacturing site and the device production unit (5) have an open schedule of sufficient duration or time periods, and within the date for delivery as selected by the customer, to perform the manufacturing operations necessary to manufacture the device ordered by the customer. The open schedule is sufficiently lengthy within a single time period that manufacturing operations are performed without interruption from start to finish during an open schedule. Alternatively, the open schedule has a series of sufficiently lengthy time periods within which portions of the manufacturing operations are performed without interruption during each of such time periods of the open schedule. The seller's computer (3) schedules manufacturing of the device during the open schedule. A supply chain processor (724) stores and retrieves information stored in a supply chain data base (726), and is used by the seller's computer (3) by way of the communications network (2) to perform supply chain functions. As examples of supply chain functions, the seller's computer (3) operates to notify supply chain managers, who are employees of the seller or of the customer, or who are vendors of goods and services to the seller or to the customer, with information about supplying the materials needed to manufacture the tangible device ordered by the customer. Further, the seller's computer (3) notifies the supply chain managers of the need for site set-up and maintenance of the production unit to operate during the manufacturing schedule allotted for manufacture of the tangible device, as ordered by the customer. This information and notification enables readiness in advance of the manufacturing schedule, and anticipates the amount to which materials need replenishment when manufacturing occurs according to the manufacturing schedule. A schedule and order fulfillment processor (728) stores and retrieves information stored in a schedule and order fulfillment data base (730), and is used by the seller's computer (3) to create an order fulfillment schedule and an order status tracking report for verifying the status of the order. The order is confirmed to the customer, along with confirmation of the production unit and the manufacturing schedule within the delivery date as ordered by the customer. The customer uses the order status tracking report to provide inquiries of the seller's computer (3) about the status and whereabouts of the order and device that was ordered.

The invention includes a device production unit (5) located at a single site selected by the customer. The seller's computer (3) determines whether the production unit (5) at the selected site is of a configuration that is capable of producing the tangible device upon demand, whose size, shape, and attributes are determined by the seller's computer (3), and whether component parts or raw materials are on-site, meaning, present at the site, and loaded into a production mode. The seller's computer (3) further determines the manufacturing process required to manufacture the tangible device, determines the time schedule required to perform the manufacturing process, and schedules and controls the manufacturing process performed by the production unit (5).

The system according to the invention differs from a known system that uses a communications network for synchronous manufacture and assembly of tangible devices, but requires shipping and payment of shipping charges. The customer lacks a property interest in the manufacturing apparatus, and is unable to assess costs of production. The known system is useful for supplying numerous customers who are consumers of tangible devices, such as a personal computers. The known system is ill suited for supplying an industrial customer with a tangible product used for industrial production, because the customer is dependent upon shipping, and being without a property interest in the production unit or manufacturing apparatus, is unable to assess costs of production. The seller is unable to anticipate scheduling of manufacturing, as well as, inventory of materials and finished goods, and the justification for investment in manufacturing apparatus and manufacturing sites. By contrast, the device production unit (5) is a computer controlled apparatus, which fabricates the finished article on demand based on the coded information given to it by the seller's computer (3). The customer has a property interest in the device production unit (5), and is able to assess costs of production, demand for finished goods and the justification for investment in the production unit (5) and the manufacturing site. The invention provides a customer with a tangible device used in manufacturing, which enables the customer to have an integrated manufacturing site. While the present invention is for the purchase, manufacture and delivery of quantities of industrial parts or other tangible devices by a commercial concern or manufacturing operation, it can also easily produce tangible devices of a variety of types to individual consumers that have access to corresponding manufacturing sites of their choosing.

FIG. 8 discloses a computer operated system and apparatus (800) installed at a manufacturing site, as selected by the customer. The system (800) is connected to and is controlled by the manufacturing control computer (4). The system (800) is disclosed with a distributed architecture that includes a router (802) for routing digital communications among distributed sections or parts of the apparatus (800). A nondistributed architecture or integrated architecture eliminates the need for the router (802). A manufacturing processes processor (804) stores and retrieves information from a manufacturing processes data base (806), and is used by the seller's computer (3) to determine the manufacturing processes that the device production unit (5) is able to perform at the manufacturing site, and to arrange the sequence of production processes that result in manufacture of the device as ordered by the customer. Upon determination of the sequence of production processes, the time required to perform the processes is determined, and is scheduled for performance. A supply chain fulfillment processor (808) stores and retrieves information stored in a supply chain fulfillment data base (810), and is used by the seller's computer (3) to verify that the supply chain functions, as previously defined herein, have been fulfilled by supply chain managers, who have acted in response to notifications of such supply chain functions, at step (112), and as performed by the seller's computer (3) by using the supply chain processor (728) and the information retrieved from the supply chain data base (730). The readiness of the device production unit (5) for performing the manufacturing operations is verified by the supply chain processor (808) to the seller's computer (3). A site schedule processor (812) stores and retrieves information stored in a site schedule data base (814), and is used by the seller's computer (3) to determine open schedules within which to schedule manufacturing operations and maintenance on the device production unit (5). A production fulfillment processor (816) stores and retrieves information stored in a production fulfillment data base (818), and is used by the seller's computer (3) to determine which portion of the production operations is being performed by the device production unit (5), and the completion of each portion of the production operations as they are completed. The seller's computer (3) further uses the information stored in the data base (818) to accumulate increasing needs for supply chain management, such as, materials replenishment, site set up and maintenance scheduling. A maintenance processor (820) stores and retrieves information from a maintenance data base (822), and is used by the seller's computer (3) to schedule maintenance and to obtain information input to the processor (820) that scheduled maintenance has been fulfilled, as completed by the supply chain managers.

A single site, device production unit (5) includes; ink jet printing units and digitally controlled cutting and grinding units and digitally controlled stereolithography units. Of these, ink jet printing units are particularly desirable to construct a tangible device by one or more than one molecular dispersion in place of conventional inks. Three dimensional solid objects can readily be built up, successively, layer by layer in any shape and dimension, limited only by the droplet resolution of the ink jet delivery system. Based on conventional machines now commercially available, the droplet resolution is below 100 microns, allowing a wide variety of precisely dimensioned devices to be fabricated. Commercially available stereolithography units currently used for solids fabrication can produce devices of considerable mass and shape complexity from molecules of liquid phase materials that cure to a solid phase. Digitally controlled cutting and grinding units can shape devices, such as gaskets, gears, or integrated circuit carriers from a roll or sheet of a bulk raw material.

A wide variety of tangible devices are produced by an accumulation of molecules of a single material or by fabricating successive layers of single materials. More technologically advanced production units are capable of fabricating a tangible device by selective placement of molecules of different materials allow a fuller use of the present invention, as they have the potential for manufacturing highly complex, tangible devices having a multiplicity of component parts. One example of such a production unit is a nanosynthesizer, which assembles articles molecule by molecule under instruction from a computer.

While any one type of the production units (5) described above is used by itself, it may also be desirable to combine the features of more than one type into a single production unit (5). For example, a production unit (5) includes, an ink jet unit that performs a process to create a sheet of material having useful features and structural shapes, and a digitally controlled, bulk cutting device that immediately follows to cut out a portion of the sheet of material to provide a tangible device, as ordered by the customer.

The system according to the invention is adapted to provide automated manufacture and delivery of tangible devices that are used by an industrial customer in the customer's manufacturing operations. This allows customers to rapidly reconfigure their manufacturing operation without maintenance of expensive parts inventories and without supply chain disruption due to inefficiencies of operations, transportation problems, weather, etc.

An embodiment of a tangible device that is suitable for manufacture according to the invention is one that is manufactured by an accumulation of molecules of material, and/or is fabricated by successive layers of material. For example, an embodiment of a tangible device includes a polishing pad of the type used for CMP, chemical mechanical planarization, a process of polishing a semiconductor substrate with a planar, smooth polished surface. A further embodiment includes a tangible device used to hold, and to secure and to clean, an article to be polished by a polishing pad.

An embodiment of the present invention involves the selection, purchase, and delivery of polishing pads to a customer's manufacturing site. Polishing pads are sheets of polymer based material, typically less than 5 mm thick, which are used on a polishing machine for smoothing and finishing a wide variety of articles, including the surfaces of semiconductor substrates for fabrication of integrated circuits. While polishing pads are manufactured from few basic materials, they are constructed in a wide variety of attributes that includes, size, shape, thickness, texture, patterns of perforations, pores, grooves, and other physical and chemical features that can be constructed and duplicated by accumulation of molecules of materials. Prior to the invention, large inventories of bulk goods, usually in roll form, are cut or otherwise modified into finished polishing pads on receipt of a customer order. This is a relatively slow and tedious process which results in high cost to customers. It is also relatively difficult and expensive to make design changes to the pads. Using a system according to the invention, a customer selects and orders a desired polishing pad of desired material and design, which pad is manufactured on demand directly at the location of use without significant human intervention. Because polishing pads are thin sheet objects, digitally controlled ink jet techniques are particularly useful in their manufacture.

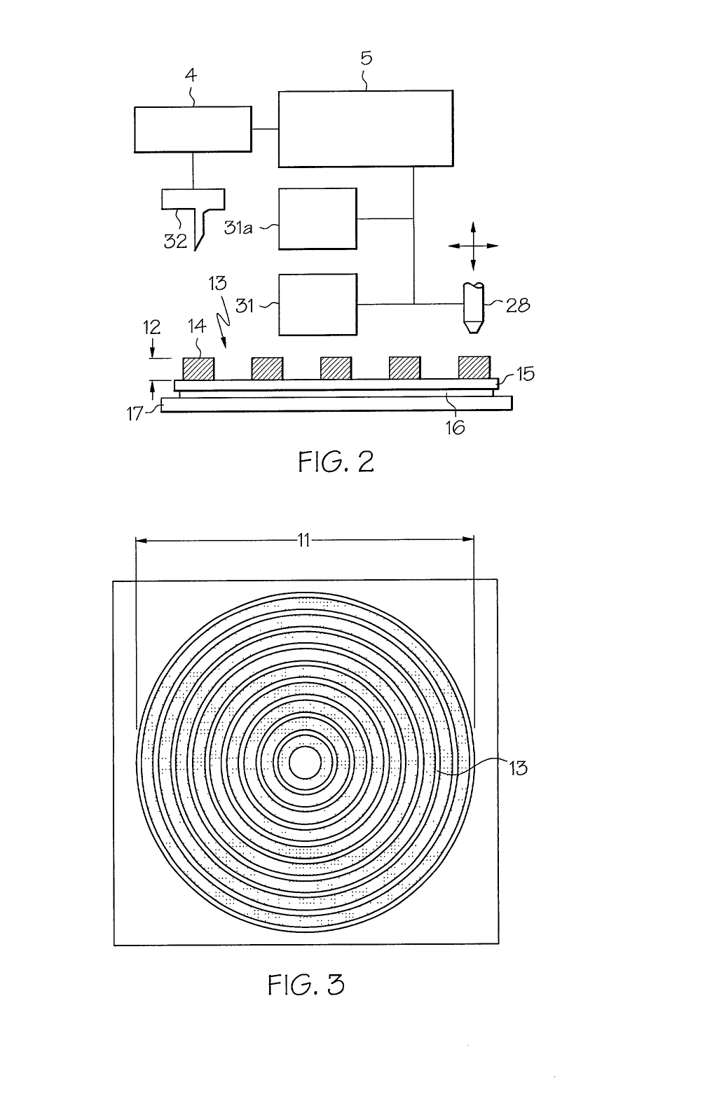

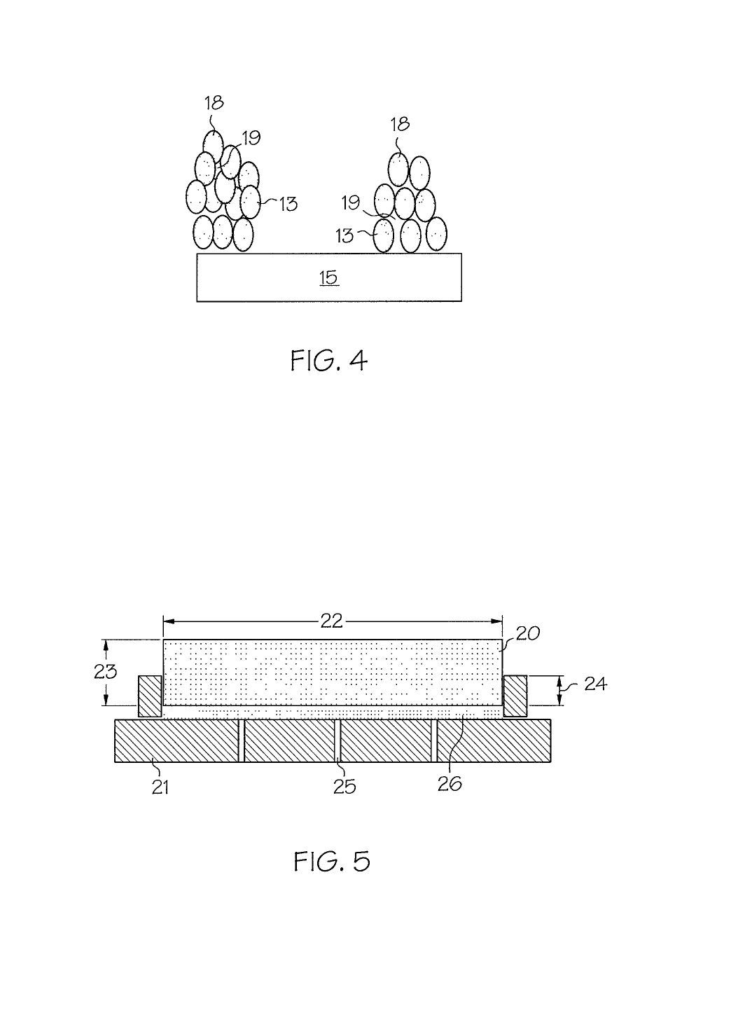

Schematic diagrams of polishing pad as devices according to the present invention are disclosed by FIGS. 2, 3 and 4. A polishing pad is fabricated of thin sheets of multilayered polymer. The pad is used in conjunction with a polishing fluid, for example, a water based dispersion of submicron abrasive particles (slurry). FIG. 2 discloses, a typical pad having an upper, or active surface layer (14) of some thickness (12) that includes a polymer of a controlled porosity. The upper surface layer (14) is bonded to a substrate fabricated of a sheet of backing film (15) whose upper surface is capable of being wetted by uncured liquid phase polymer used to fabricate the upper layer. The lower portion of the backing film (15) is bonded to a pressure sensitive adhesive (PSA) film (16) that is covered by a peel to remove, polyester release liner (17) that protects the PSA from contamination until use. CMP polishing machines use a rotary motion or orbital motion that require a circular pad, or that use a pad in continuous belt constructions.

In order to control the hydrodynamic properties of a film of fluid between a polishing pad and a substrate being polished by CMP polishing, macrotexture (13) is built into the surface layer (14). This macrotexture (13) includes; grooves, or other recessed features of a dimensional width usually at least 2 times the surface layer thickness (12). A wide variety of groove patterns is employed, including radial, concentric, square cross-hatched, hexagonal cross-hatched, and irregular. Other types of macrotexture include; isolated recesses and fractal patterns.

The hardness and stiffness of the upper layer (14) is adjusted to suit the requirements of the polishing operation for which it is employed, by varying the type of polymer used, varying the porosity, and by incorporating material in other phases or states, such as, liquid, solid, ionic, molecular or crystalline phases or states. The invention is suitable for manufacturing a tangible device from a polymer that includes, but is not limited to, acrylates, polyurethanes, polystyrenes, polyesters, polysulfones, nylons, epoxies, natural and synthetic rubbers, and copolymers of two or more polymer species. These polymers are of various classes, including, but not limited to, aqueous latexes, solution polymers (i.e., polymers dissolved in a solvent that polymerize as the solvent evaporates), mix and set polymers, thermoplastic polymers, thermoset polymers, or photo-cured polymers. Each type and class of polymer has particular advantages for manufacture of a tangible device with selected attributes including, size, shape, porosity, texture, hardness, hydrofilicity, hydrophobicity, other properties of materials and materials phase selection.

Porosity of the upper layer (14) is created by a number of techniques, including, but not limited to, coagulation processes, the incorporation of foaming or blowing agents, the use of porous filler particles, and the dropwise accretion or buildup of the surface layer. These manufacturing operations are performed by the accumulation of droplets (18) of materials distributed in a pattern from an ink jet printer. When appropriate digital signals are sent from the seller's computer (3) to the control computer (4) that controls the device production unit (5) or manufacturing apparatus, such as, an ink jet printer, the computer (4) directs the printer to deposit a patterned area layer of droplets (18) of polymer, that includes, one or more than one, of; a monomer, a polymerizing agent, a foaming agent and a blowing agent, onto the upper surface of the printing substrate (15) in the desired pattern. The macrotexture (13), such as, grooves in the polishing pad are produced by a continuous elongated interruption of the droplets of polymer in the selected areas bounded by the grooves. The polymer of liquid phase is cured to a polymerized, molecular, crystalline, or foamed stage, as required by heating, air drying, foaming, or some other curing operation.

Raised thickness portions of the upper layer (14) are created by successive layers of deposited droplets of polymer in a digitally controlled area pattern. Pad porosity is produced by varying the material mass density of the droplets (18) deposited on the substrate (15), so that voids (19) exist in desired sizes and area patterns of distribution within the area pattern of deposited droplets (18). Varying degrees of porosity are created by varying the spacing and density of droplets (18). The variation in porosity is created in any manner desired, including within specific areas of the pad in depth, and in lateral location within the area pattern. Further, the droplet size resolution of the ink jet printing apparatus allows for discrete molecular distribution of a material over an area pattern of molecular size thickness. By repeated distribution of a material, the thickness is increased. Further, by varying the material content of the molecules, creation of polishing pads with novel physical properties are created.

Depending on the thickness desired, more than one layer of deposition is employed. Typically a single deposition layer will occur across the desired pad dimension in a single pass, and thickness is built up in multiple printing passes. This manner of multilayer deposition also readily allows the creation of pads whose upper layer has selected single physical properties or varied physical properties (e.g., porosity, density, structure), that allows creation of pads with novel physical properties.

Yet another manner of modifying the physical properties of the upper pad layer is to add additional phases of material. These is liquid, present in droplets or as an interconnected network of an immiscible phase, gaseous (to create porosity), or solid, either as organic or inorganic particles. The incorporation of one or more than one additional phase can be used to create porosity, increased modulus, or, by addition of submicron abrasive particles, create a fixed abrasive polishing pad that possesses sufficient polishing activity that it is used without the companion slurry normally employed. Such slurryless polishing operations provide significantly lower cost to the user as expensive slurries do not have to be employed, reducing initial cost as well as waste disposal costs. For an ink jet operation, the size of the particles is limited to less than 25% of the orifice cross section of the ink jet nozzle in the print head, typically about 50 microns. Types of inorganic particles include, but are not limited to, metals, salts, hydroxides, hydrous oxides, and oxides. Useful cations of the above compounds include, but are not limited to cations of the elements of the first, second, and third columns of the periodic table, transition metals, and lanthanides. Anions useful with the above cations include, but are not limited to, halides, nitrates, nitrites, sulfates, sulfides, peroxides, perchlorates, periodates, persulfates, and organic anions such as citrates and phthalates. Particles of oxides are of particular utility in the present invention, as they are commonly employed as abrasive particles in polishing fluids or slurries and in fixed abrasive pads. Oxides include, but are not limited to, SiO₂, AL₂O₃, TiO₂, CeO₂, and ZrO₂.

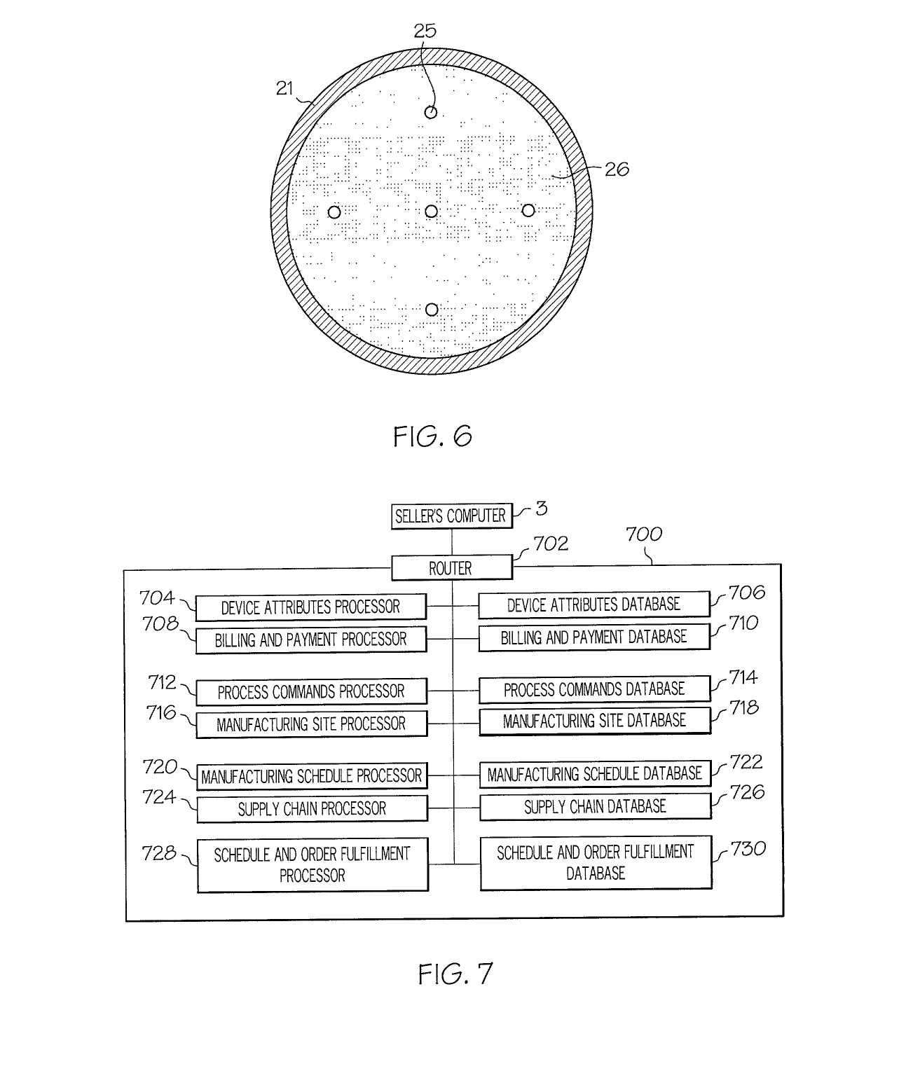

Other component parts used in apparatus to perform CMP the polishing process, include; the fixturing carrier used to hold a wafer in place during polishing, which is suitable for production by a system according to the present invention. FIG. 5 discloses a cross-sectional view of a typical carrier (21) with a semiconductor wafer or substrate (20) mounted in place. FIG. 6 discloses a top view of a known carrier (21). A carrier (21) is fabricated as a sheet of polymer, usually polyurethane, that have a recess (24) or pocket in which the substrate or wafer (20) registers or sits. The inner diameter (22) of the recess (24) is just slightly larger than the diameter of the substrate or wafer (20) for ease of insertion into the recess. The perimeter of the recess restricts lateral movement of the substrate or wafer (20) from the recess (24). In ordinary practice, the depth of the recess (24) in which the wafer (20) registers or sits is approximately ¾ of the wafer thickness (23). This recess depth, provides enough edge contact to prevent lateral movement of the wafer (20) out of the carrier (21), yet allows a protruding substrate or wafer (20) for free and unobstructed contact between a protruding wafer surface and the polishing pad. Wafer carrier (21) has vacuum through holes (25) for regulation of fluid borne vacuum or pressure exerted against the back side of the wafer (20) as it is being polished. Applied vacuum or pressure is uniformly distributed to uniformly distribute polishing over the surface of the wafer or substrate (20). Changing the vacuum or pressure assists in removal of the wafer (20) from the carrier (21).

Another component part of the carrier (21) is a thin sheet of soft flat polymer film, commonly called a mounting film (26), that acts to hold the wafer or substrate (20) in the recess (24) by capillary action. A mounting film (26) must be soft and conformal to the wafer or substrate (2), to prevent ingress and trapping of particles between the film and the back surface of the wafer or substrate (20) that would impede uniform distribution of polishing, or would damage the wafer or substrate (20). Such a mounting film (26) is a tangible device for which the invention is especially adaptable to manufacture.

### EXAMPLE 1

According to an example, a customer uses a computer (1) to contact a computer representing the seller (3) via a communications network (2) and places a request to purchase an article from a menu of selections of polishing pads for purchase. Attributes selected by the customer include diameter (11), thickness (12), macrotexture (13), and the material, physical and chemical properties of the upper active pad layer (14). The attributes are graphically illustrated on the seller's web site, and are apparent from a sample pad as disclosed by FIG. 2. In this example, the pad ordered has a concentric circular groove pattern as the macrotexture (13). The customer's order contains billing and payment information confirming the customer's ability to pay for the device purchased. The seller's computer (3) uses the credit information to transfer payment from customer to seller via the communications network (2). Digital information is transmitted from the seller's computer (3) to a system control computer (4) which directs a device production unit (5) located at a site selected by the customer to manufacture the ordered item.

The device production unit (5) in this example is disclosed by FIG. 2, and includes, a printer 28 in the form of a Mimaki JV2-1 30 piezoelectric ink jet plotter with an Ethernet network adapter, connected to the control computer (4), which is connected to the seller's computer (3) via the Internet as the communications network (2). A material consumed by the production unit (5) includes, a substrate in the form of a roll of 0.010″ thick, polyurethane backing film (15) whose upper surface is adaptable for being wetted by the polymer dispensed by the ink jet device. The lower portion of the backing film (15) is bonded to a pressure sensitive adhesive (PSA) film (16) and a peel away, polyester release liner (17) that covers and protects the PSA from contamination until use. The ink jet reservoir 31 of the printer 28 contains a polyurethane latex which is used to produce the polishing layer (14) of the polishing pad ordered by the customer. The printing substrate roll of backing film (15) is fed into the inlet side of the printer 28.

When the appropriate digital signals are sent from the seller's computer (3), the control computer (4) directs the printer 28 to deposit a layer of droplets (18) of the urethane latex onto the upper surface of the printing substrate (15) in a desired area pattern. The grooves (13) in the polishing pad are produced by interruption in the deposit of droplets (18) of urethane latex in selected areas. Raised thickened portions of the pad are created by selectively depositing droplets of urethane latex layer upon layer, in successive layers. Pad porosity is produced by varying the density of the deposited droplets (18) so that voids (19) exist in among the deposited droplets (18). Depending on the thickness desired, more than one layer of deposition is employed. Typically a single deposition layer will occur across the desired pad dimension in a single pass, and thickness is built up in multiple printing passes, using one or more than one printing nozzle. Once the desired thickness is achieved, the production unit (5) advances the substrate roll (15) and the printed portion is cut off with a bulk media cutter 32, creating the desired polishing pad. The customer uses the polishing pad in a CMP polishing operation by, first, removing the release liner (17) to expose the adhesive (16) that is used to attach the pad to a table of a known CMP polishing apparatus.

### EXAMPLE 2

In this example, instead of a simple polyurethane latex, the customer selects a particle filled latex as the constituent material of the surface layer (14). As in the previous example 1, the control computer (4) directs the printer (28) of the production unit (5) to deposit a layer of droplets (18) of the urethane latex containing a dispersion of approximately 25% by weight of submicron CeO₂ particles onto the upper surface of the printing substrate (15) in the desired pattern. This CeO₂-containing latex dispersion is contained in a separate liquid reservoir 32a from the simple urethane latex of example one, with both reservoirs 32 and 32a independently connected to the ink jet printer 28. Thus two entirely different types of polishing pads can be created from the same device production unit (5).

EXAMPLE 3

In this example, attributes selected by the customer include the pocket or recess diameter (22) for carrying the wafer or substrate 23 during a CMP polishing operation, pocket or recess depth (24), and position of fluid borne vacuum or pressure through holes (25), and the required dimensions and thickness of the mounting film (26). In this example, the customer chooses a 200 mm wafer diameter, a total thickness of 1200 μm, a pocket depth 750 um, and 5 vacuum through holes. The device production unit (5) in this example consists of a 3D Systems SLA-250 HR stereolithography system with an Ethernet network adapter, connected to the control computer (4). The stereolithography system uses a focused 6-mW HeCd laser emitting light at 325 nm. to selectively cure thin layers of RPC-IOOND resin in a digitally controlled manner in order to build up a solid device, layer by layer in a manner analogous to the operation of the ink jet printer 28, as described in Examples 1 and 2.

The control computer (4) directs the stereolithography device 28 to build the carrier 21 layer by layer. Using a focused beam diameter of 75 um directed at a surface of droplets 18 to be cured, produces a cured layer thickness of 50 microns per pass. The carrier 21 is built to the desired thickness dimensions after twenty-four passes of the device 28 over the area pattern of the carrier 21.

EXAMPLE 4

According to this example, the production unit (5) is used to manufacture a mounting film (26) whose dimensions match those required for use in the carrier 21. The Mimaki JV2-1 30 ink jet printer 28 uses a feed roll of urethane substrate (15) similarly as in Example 1. In this example, the substrate (15) is fed into a Mimaki CF-1218TD cutting plotter 32.

The control computer (4) directs the printer 28 to deposit a layer of droplets (18) of urethane latex onto the upper surface of the printing substrate (15) in the desired area pattern. When the mounting film 26 is built up by repeated layers of droplets (18) to the desired dimensions and surface layer thickness, the production unit (5) advances the printed portion of the substrate (15) to the working area of the cutter plotter 32. The control computer (4) directs the cutter plotter 32 to cut the peripheral diameter and vacuum or pressure transporting holes 25 to the desired dimensions and locations to produce the finished device according to the customer's order.

Although embodiments of the invention are disclosed, other embodiments and modifications are intended to be covered by the spirit and scope of the appended claims.

What is claimed is:

1. A system by which a customer determines ordering, manufacturing at a selected site and delivery without shipping of a tangible device sold by a seller, comprising:
a seller's computer receiving an order for a tangible device from a customer, selecting manufacturing process commands to manufacture the device as ordered, verifying that the site has the capability and an open schedule to manufacture the device as ordered, scheduling the manufacturing during the open schedule, and providing an order fulfillment schedule and status tracking of the order,
a manufacturing control computer providing manufacturing process commands to a production unit at the site, the manufacturing control computer providing a site schedule and a record of maintenance fulfillment indicating capability and readiness of the production unit to manufacture the tangible device, and
a production unit at the site adapted for manufacture of the tangible device substantially without human intervention upon direction of manufacturing process commands supplied by the manufacturing control computer.

2. The system according to claim 1 wherein, the production unit comprises a stereolithography forming machine.

3. The system according to claim 1 wherein, the production unit comprises an inkjet printer adapted to deposit droplets of liquid phase polymer material.

4. The system according to claim 1 wherein, the manufacturing control computer comprises; a manufacturing processes processor storing and retrieving information from a manufacturing processes data base, and adapted for use by the seller's computer to verify the property interest of the customer in the production unit.

5. The system according to claim 1 wherein, the manufacturing control computer comprises; a supply chain fulfillment processor storing and retrieving information from a supply chain fulfillment data base and providing a record of supply chain managers and a supply chain fulfillment report indicating completion of supply chain instructions and the readiness of the production unit.

6. The system according to claim 1 wherein, the manufacturing control computer comprises; a site schedule processor storing and retrieving information from a site schedule data base, and providing the seller's computer with a maintenance schedule, a production schedule and an open schedule for the production unit.

7. The system according to claim 1 wherein, the manufacturing control computer comprises; a production fulfillment processor storing and retrieving information from a production fulfillment data base, and adapted for use by the seller's computer to provide the customer with an order tracking and order fulfillment report.

8. The system according to claim 1 wherein, the production unit comprises; a maintenance fulfillment processor storing and retrieving information from a maintenance fulfillment data base, and adapted to provide a record of maintenance fulfillment.

9. The system according to claim 1 wherein, the seller's computer comprises; a device attributes processor storing and retrieving information from a device attributes data base, and adapted to provide a customer with numerous tangible devices for selection by the customer according to the device attributes.

10. The system according to claim 1 wherein, the seller's computer comprises; a billing and payment processor and a billing and payment data base verifying payment for the tangible device ordered by the customer, and for determining the property interest of the customer in the production unit.

11. A process by which a customer determines ordering, manufacturing at a selected site and delivery without shipping of a tangible device sold by a seller, comprising:
receiving an order for a tangible device from a customer,
selecting manufacturing process commands to manufacture the device as ordered,
verifying that the site and a production unit at the site have the capability and an open schedule to manufacture the device as ordered,
scheduling the manufacturing during the open schedule,
providing an order fulfillment schedule and status tracking of the order,
providing a site schedule and a record of maintenance fulfillment indicating capability and readiness of the production unit to manufacture the tangible device,
providing manufacturing process commands to a production unit at the site, and
manufacturing the tangible device substantially without human intervention upon direction of manufacturing process commands supplied by a seller's computer to a manufacturing control computer.

12. The process according to claim 11 wherein, the step of manufacturing the tangible device substantially without human intervention further includes the step of forming the device by a stereolithography forming machine.

13. The process according to claim 11 wherein, the step of manufacturing the tangible device substantially without human intervention further includes the step of successive molecular deposition onto an area pattern.

14. The process according to claim 11, and further including the steps of verifying the property interest of the customer in the production unit, and apportioning according to the property interest the income, interest, depreciation, taxes, insurance and financial accounting adjustments.

15. The process according to claim 11, further including the steps of; providing a record of supply chain managers, and providing a supply chain fulfillment report indicating completion of supply chain instructions and the readiness of the production unit.

16. The process according to claim 11, further including the step of; providing a maintenance schedule, a production schedule and an open schedule for the production unit.

17. The process according to claim 11, further including the steps of; storing and retrieving information from a production fulfillment data base, and providing the customer with an order tracking and order fulfillment report.

18. The process according to claim 1, further including the step of; providing a record of maintenance fulfillment indicating readiness of the production unit.

19. The process according to claim 11, further including the step of; providing a customer with numerous tangible devices for selection by the customer according to device attributes of the tangible devices.

20. The process according to claim 11, further including the step of; verifying payment for the tangible device ordered by the customer, and determining the property interest of the customer in the production unit.
